(19) United States
(12) Patent Application Publication
(10) Pub. No.: US 2023/0008360 A1
(43) Pub. Date: Jan. 12, 2023

(54) SYSTEM AND METHOD FOR INDEPENDENT SCORING OF LANDLORDS AND TENANTS

(71) Applicant: Kristi Hilyard, Walton, KY (US)

(72) Inventor: Kristi Hilyard, Walton, KY (US)

(21) Appl. No.: 17/859,674

(22) Filed: Jul. 7, 2022

Related U.S. Application Data
(60) Provisional application No. 63/218,993, filed on Jul. 7, 2021.

(51) Int. Cl. G06Q 30/02

(52) U.S. Cl. CPC G06Q 30/0282

(57) ABSTRACT

The present invention relates to a rating and scoring system and application for landlords and tenants. The system allows both landlords and tenants to obtain a preview of how each other operates prior to signing a lease, ensuring both parties can maintain a positive working relationship. The system is configured to use a plurality of ranking parameters for the landlords and tenants wherein the tenants and other landlords registered in the system provide ranking for a landlord and similarly, the landlords and other tenants may provide ranking for a tenant. An average of all the rankings for a tenant and landlord is used for an overall score. The overall score along with individual parameter ranking provide a quantitative representation of quality of the tenant and landlord and enables individuals to find compatible landlords and tenants.

### CROSS-REFERENCE TO RELATED APPLICATION

The present application claims priority to, and the benefit of, U.S. Provisional Application No. 63/218,993, which was filed on Jul. 7, 2021 and is incorporated herein by reference in its entirety.

### FIELD OF THE INVENTION

The present invention relates generally to the field of renter systems. More specifically, the present invention relates to a computer implemented method and system for ranking and scoring landlords and tenants on a variety of parameters to identify behavior patterns for renting homes, apartments, and other properties. The system allows tenants to provide rankings to landlords and other tenants and similarly, landlords can provide rankings to tenants and other landlords. Using the scoring system, the system allows both landlords and tenants to obtain a preview of how each other operates prior to signing a lease, ensuring both parties can maintain a positive working relationship. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals who owns homes, buildings, offices, and more rent out spaces to create a passive income. Renting also helps in maintaining their properties as tenants maintain the space while living. However, landlords often face a lot of unpredictable problems with tenants, wherein many of the problems are due to the behavior of tenants. Generally, landlords only check the credit ratings and history of a tenant for avoiding late payments and therefore, unpredictable problems like lack of communication, maintenance problems, noise, damages to the property, and more are faced by landlords due to lack of thoroughly checking the tenant before leasing the property. Currently, there is no method for landlords to do a thorough check of the potential lessees and to have a preview of a positive working relationship with a tenant.

Individuals who have poor credit ratings face a challenge to find a good place to rent. Such individuals may be good tenants and maintain a good and healthy relationship with landlords but due to poor credit ratings, they do not easily secure desired places. Such individuals desire a system and a method that can process thorough background checks by obtaining feedback from their previous landlords to overcome the dependency on credit ratings for the tenant identification.

In many scenarios, the tenants may be good but the landlords may have bad business practices. Landlords may create noise, trouble the tenants, avoid property maintenance, or have a history of fights and malpractices. There is currently no system available for tenants to check the quality or responsiveness of a landlord before renting a place which may lead to a negative working relationship between the lessor and lessee.

Therefore, there exists a long felt need in the art for a system and method that helps landlords in identifying good tenants. There is also a long felt need in the art for a system and method that helps tenants in identifying good and compatible landlords. Additionally, there is a long felt need in the art for a system and method that offers more parameters to judge tenants rather than just credit ratings. Moreover, there is a long felt need in the art for a system and method that helps tenants in identifying landlords who have good business practices. Further, there is a long felt need in the art for a system and method that allows both landlords and tenants to obtain a preview of how each other operates prior to signing a lease. Finally, there is a long felt need in the art for a system and method that enables individuals to find places to rent without a credit report or background check.

The subject matter disclosed and claimed herein, in one embodiment thereof, comprises a computer implemented method for allowing landlords and tenants to obtain a preview of quality of each other based on an overall score assigned to each of the landlords and tenants. The method further comprising the steps of receiving, by a server from a plurality of tenant user applications, a score on each of a plurality of ranking parameters defined for a landlord; calculating, by a landlord scoring module, an average of the received scores for the landlord; calculating, by the landlord scoring module, an overall score for the landlord, wherein the overall score falls in one of eleven tiers of scoring; providing, by the server, the overall score of the landlord to a tenant user application enabling the tenant to obtain a preview of the quality of the landlord before leasing a property of the landlord. Similarly, the server provides an overall score of a tenant based on average of the scores received from other tenants and landlords wherein the tenant overall score can be viewed by a landlord.

In this manner, the landlord and tenant rating system and associated application of the present invention accomplish all of the forgoing objectives and provide users with a rating and scoring system for lessors and lessees capable of identifying behavior patterns for renting homes, apartments, and other properties. The system features multiple individual categories that can be assigned a score to provide a visual representation of quality of a landlord and a tenant. The system allows both landlords and tenants to obtain a preview of how each other operates prior to signing a lease, ensuring both parties can maintain a positive working relationship. The system is not dependent only on credit reports and offers relevant parameters for assigning an overall score to both landlords and tenants.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer implemented method for allowing landlords and tenants to obtain a preview of quality of each other based on an overall score assigned to each of the landlords and tenants. The method further comprising the steps of receiving, by a server from a plurality of tenant user applications, a score on each of plurality of ranking parameters defined for a landlord; calculating, by a landlord scoring module, an average of the received scores for the landlord; calculating, by the landlord scoring module, an overall score for the landlord, wherein the overall score falls in one of eleven tiers of scoring; providing, by the server, the overall score of the landlord to a tenant user application enabling the tenant to obtain a preview of the quality of the landlord before leasing a property from the landlord.

In yet another embodiment, the plurality of ranking parameters for landlords includes move-in conditions, speed of repairs, quality of repairs, conditions of the property, complaint history, and more.

In yet another embodiment, the computer implemented method further comprising receiving, by the server from a plurality of landlord user applications, a score on each of a plurality of ranking parameters defined for a tenant; calculating, by a tenant scoring module, an average of the received scores for the tenant; calculating, by the tenant scoring module, an overall score for the tenant, wherein the overall score falls in one of eleven tiers of scoring; providing, by the server, the overall score of the tenant to a landlord user application enabling the landlord to obtain a preview of the quality of the tenant before leasing a property to the tenant.

In yet another embodiment, the plurality of ranking parameters for tenants includes timely payments, damages caused, pet history, complaint history, maintenance compliance, and more.

In yet another embodiment, a computer-readable storage medium storing non-transitory computer-executable program instructions, wherein when executed by a computing device, the non-transitory computer-executable program instructions cause a processor of the computing device to perform operations comprising receiving, from a user device, a landlord score request; transmitting, to a server, received landlord score request; receiving, from the server, requested landlord score request; and displaying, on the user device, the received landlord score.

In yet another embodiment, a computer-readable storage medium storing non-transitory computer-executable program instructions, wherein when executed by a computing device, the non-transitory computer-executable program instructions cause a processor of the computing device to perform operations comprising receiving, from a user device, a tenant score request; transmitting, to a server, received tenant score request; receiving, from the server, requested tenant score request; and displaying, on the user device, the received tenant score.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of a tenant and landlord rating system of the present invention in accordance with the disclosed architecture;

FIG. 2 illustrates an exemplary user interface provided by the rating system application of the present invention for logging in to the system in accordance with the disclosed architecture;

FIG. 3 illustrates an exemplary user interface of the rating system application showing the overall score of a landlord based on a plurality of parameters in accordance with the disclosed architecture;

FIG. 4 illustrates an exemplary user interface of the rating system application showing the overall score of a tenant based on a plurality of parameters in accordance with the disclosed architecture;

FIG. 5 illustrates an exemplary user interface of the rating system application allowing a tenant to search for a property and check scoring reports of the landlord and other tenants of the property in accordance with the disclosed architecture;

FIG. 6 illustrates an exemplary user interface of the rating system application allowing a tenant to search landlords in a specific score range for leasing a property in accordance with the disclosed architecture;

FIG. 7 illustrates an exemplary user interface of the rating system application allowing a tenant to contact a landlord and make payment in accordance with the disclosed architecture;

FIG. 8 illustrates a flow chart depicting a process for providing overall score/rating of landlords by the landlord and tenant rating system of the present invention in accordance with the disclosed architecture;

FIG. 9 illustrates a flow chart depicting a process for providing overall score/rating of tenants by the landlord and tenant rating system of the present invention in accordance with the disclosed architecture;

FIG. 10 illustrates a schematic flow chart showing how the score reports calculated by the system of the present invention are automatically distributed to lessors and lessees in accordance with the disclosed architecture;

FIG. 11 illustrates the scoring system tiers of the point value system used by the renters and landlords rating system of the present invention in accordance with the disclosed architecture; and

FIG. 12 depicts an exemplary computing device for implementing the rating system application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a system and method that helps landlords in identifying good tenants. There is also a long felt need in the art for a system and method that helps tenants in identifying good and compatible landlords. Additionally, there is a long felt need in the art for a system and method that offers more parameters to judge tenants rather than just credit ratings. Moreover, there is a long felt need in the art for a system and method that helps tenants in identifying landlords who have good business practices. Further, there is a long felt need in the art for a system and method that allows both landlords and tenants to obtain a preview of how each other operates prior to signing a lease. Finally, there is a long felt need in the art for a system and method that enables individuals to find places to rent without a credit report or background check.

The present invention, in one exemplary embodiment, is a computer-readable storage medium storing non-transitory computer-executable program instructions, wherein when executed by a computing device, the non-transitory computer-executable program instructions cause a processor of the computing device to perform operations comprising receiving, from a user device, a landlord score request; transmitting, to a server, received landlord score request; receiving, from the server, requested landlord score request; and displaying, on the user device, the received landlord score.

Embodiments of the present invention can be used in conjunction with various devices, for example, a personal computer (PC), a desktop computer, a laptop, a notebook computer, a tablet, a server computer, a handheld computer, any handheld electronic device, a personal digital assistant (PDA) device, a handheld PDA device, an on-board device, a mobile or portable device, a non-mobile or non-portable device, a display unit, a monitor, a wireless communication device, and more.

Although embodiments of the invention are not limited in this regard, the term “user” as used herein may include, for example, a landlord, a tenant, an insurance broker, a regulatory officer, a real estate investor, or the like.

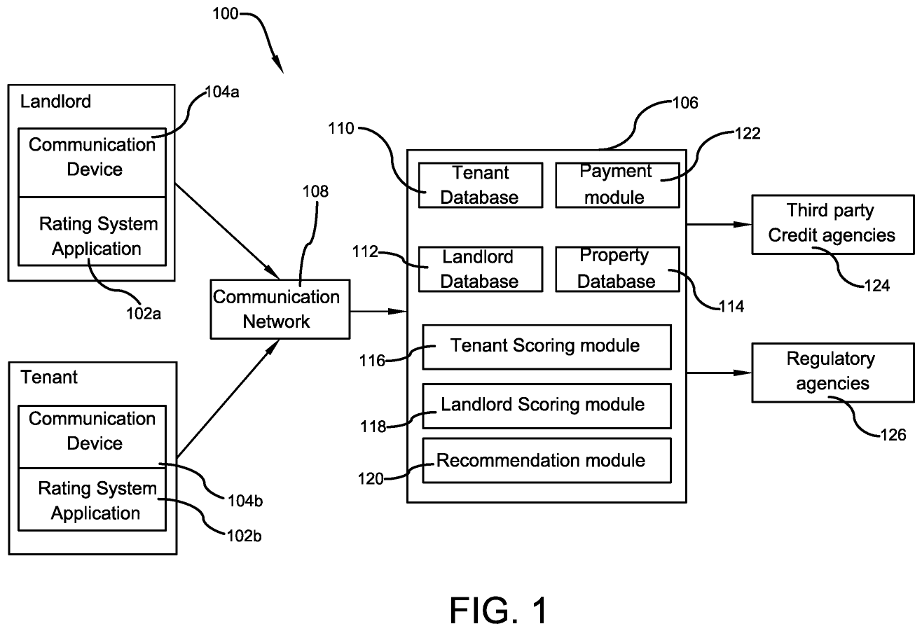

Referring initially to the drawings, FIG. 1 illustrates a schematic view of the tenants and landlord rating system of the present invention in accordance with the disclosed architecture. The tenants and landlord rating system 100 of the present invention is configured to provide users with a rating and scoring system for landlords and tenants. The system 100 uses a plurality of rating parameters for both landlords and tenants that are assigned for calculating an overall score to provide a visual indication of the behavior, performance, and credibility of the user. More specifically, the system 100 is designed to be used by landlords to validate and check a tenant before leasing a property and vice versa.

The system 100 is configured to be used by landlords and tenants but can be used by other users such as insurance brokers, government agencies, credit agencies and more. The system 100 is accessed by a user registered as a landlord using a computer implemented rating system software application 102a on a computing device 104a. The functionality provided by the computer implemented rating system software application 102a can also be provided using a website that can be accessed using a URL on a web browser. Similarly, the system 100 is accessed by a tenant using a computer implemented rating system software application 102b on a computing device 104b. The software applications 102a, 102b may provide similar or different user interfaces and can provide similar functionality allowing a user to use the application both as a landlord and as a tenant. The system 100 can be used by a plurality of landlords and a plurality of tenants for checking the respective ratings.

The applications 102a, 102b are configured to connect to a server 106 using a communication network 108. The communication network 108 can be one or more types of wireless communication signals and/or systems, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, discrete multi-tone (DMT), Bluetooth (®), global positioning system (GPS), Wi-Fi, ZigBee™, global system for mobile communication (GSM), 2G, 2.5G, 3G, 3.5G, 4G, 5G, 6G or the like.

The server 106 can be a centralized server, distributed server, cloud server or the like. The server 106 is configured to provide the user interfaces and functionality for providing ratings to the users of the system 100 using a plurality of integrated software and hardware modules as described in the present disclosure. The server 106 includes a tenant database 110 for storing tenant profiles including name, address, contact details, rent payment history, previous residential history, reviews and more. The tenant database 110 may also store any compliance failures, criminal record information, and more of tenants. Once a user is registered as a tenant in the system, the information of the tenant user, for example tenant profiles or parameters, are stored in the tenant database 110.

A landlord database 112 is configured for storing landlord profiles or parameters including landlord names, associated properties, contact details, reviews, criminal record information, previous ownership history, and more. A property database 114 stores information of all the properties of the users registered as landlords in the system 100. The database 114 also stores reviews, comments, rankings, photos, and more of the properties for allowing a tenant to easily review the property and assists in deciding to take a lease of a property.

The server 106 contains separate scoring modules for tenants and landlords wherein the scores are calculated based on the ratings and rankings of individual parameters provided by the landlords and tenants. A tenant scoring module 116 is configured for providing a plurality of ranking parameters and calculating an overall tenant score for each tenant registered in the system. The scoring module 116 is configured to provide weightages to the ranking parameters to provide an overall score for each tenant. A landlord scoring module 118 is configured for providing a plurality of ranking parameters and calculating an overall landlord score for each landlord registered in the system. The scoring module 118 is configured to provide weightages to the ranking parameters to provide an overall score for each landlord.

For helping in searching landlords, tenants and properties in a desired score range, location or more, the system 100 uses a recommendation module 120 for recommending based on the profile matching of the landlords and tenants. The recommendation module 120 may use machine learning and artificial intelligence for recommending landlords, tenants, and properties. A payment module 122 allows the users to perform payment for leasing properties using the system 100. The payment module 122 can be in the form of a payment gateway and can be a third-party integration in some embodiments of the present invention.

The server 106 is coupled to third-party credit agencies 124 such as banks and insurance agencies for receiving financial credit reports of tenants. The landlords may be provided a report or recommendation of the financial stability along with the overall score of a tenant. Further, system 100 may include a correlated payment history of a tenant with the financial reports for providing a complete and exhaustive report and score about a tenant.

For maintaining regulatory compliances of users, the server 106 couples with one or more regulatory agencies 126. Based on the comments and reviews of misconduct, illegal activities, and more about a user of the system, the server 106 is configured to provide such information to the one or more regulatory authorities 126.

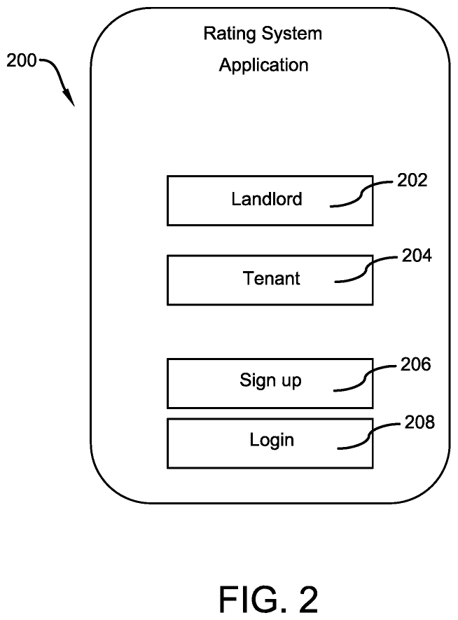

FIG. 2 illustrates an exemplary user interface provided by the rating system application of the present invention for logging in to the system in accordance with the disclosed architecture. As illustrated, the exemplary user interface 200 is the first display visible to a user and has a selectable landlord tab 202 and a selectable tenant tab 204. A sign-up button 206 is used for a user to sign up to the system 100 either as a landlord or as a tenant. Accordingly, when the user registered as a landlord, then, the application 102a is activated and provides interfaces and functionality required by a landlord. When the user is registered as a tenant, then, the application 102b is activated and provides interfaces and functionality required by a tenant. It should be appreciated that the application versions 102a, 102b are essentially similar but provides different interfaces allowing landlords and tenants to interact with the system 100.

A login button 208 is positioned below the sign-up button 206 and is used for logging in to the application. The functionality provided by the rating system application is available to users after the users are logged in to the system.

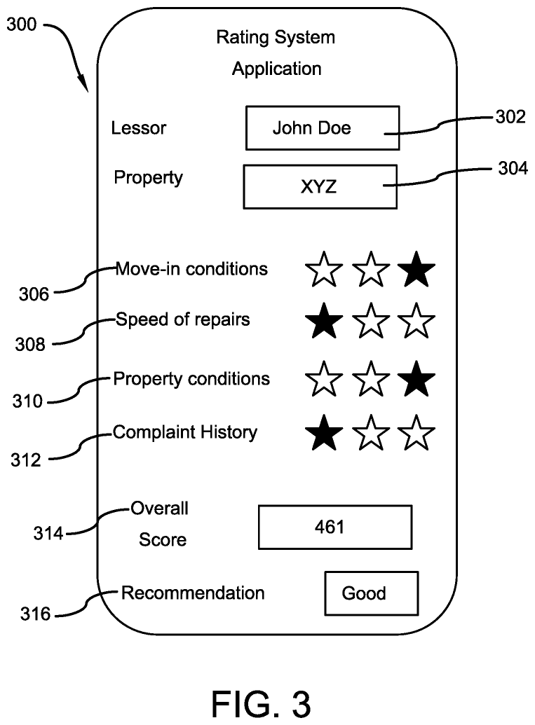

FIG. 3 illustrates an exemplary user interface of the rating system application showing the overall score of a landlord based on a plurality of parameters in accordance with the disclosed architecture. The exemplary user interface 300 displays a lessor name input box 302 for receiving a lessor or landlord name. A specific property box 304 can be used for shortlisting a specific property of the landlord and is useful in cases where a plurality of properties of the landlord are registered in the system. As described earlier, a plurality of parameters are used for ranking a landlord or a lessor and the user interface 300 displays the ranking for each individual parameter.

As an example, the user interface 300 displays ranking corresponding to move-in conditions 306 of the property, speed of repairs 308 executed by the landlord, property conditions parameter 310, and complaint history 312 of the landlord. It should be noted that the ranking can be represented in any form or manner and can be in the form a slide bar, point system, and more. The ranking for each parameter is based on the rankings, comments, and reviews provided by other users (tenants and landlords) to the system by using the application and/or website. The landlord scoring module calculates the scores and rankings for each landlord and thus are displayed on the user interface 300.

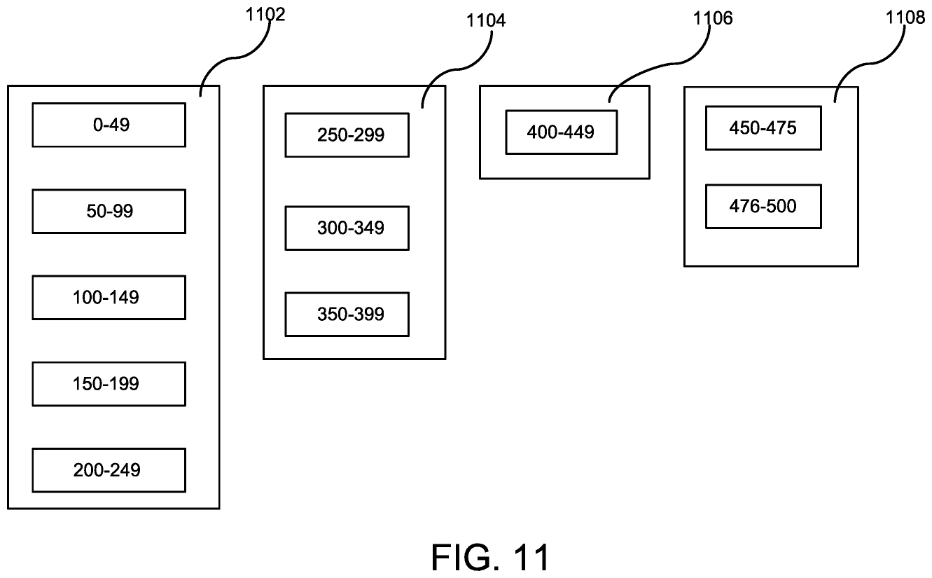

Based on the cumulative ranking parameters 306, 308, 310, 312, an overall score 314 is automatically calculated by the system 100 and is displayed as the overall score. The overall score 314 lies in one of the eleven tiers of scoring defined in the system 100 as illustrated in FIG. 11. Along with the overall score 314, a recommendation 316 for the landlord is also provided suggesting to a tenant to decide to take a lease of the property from the lessor.

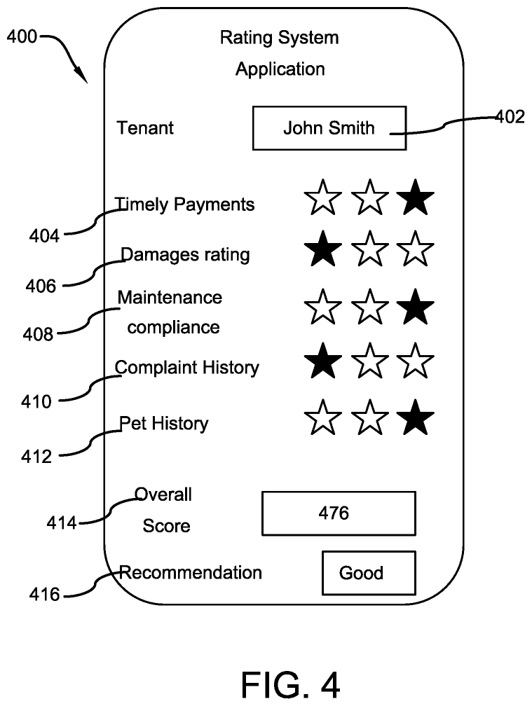

FIG. 4 illustrates an exemplary user interface of the rating system application showing the overall score of a tenant based on a plurality of parameters in accordance with the disclosed architecture. The exemplary user interface 400 displays a tenant name input box 402 for receiving a tenant name whose score is to be checked. As described earlier, a plurality of parameters can be used for ranking a tenant and the user interface 400 displays the ranking for each individual parameter.

As an example, the user interface 400 displays ranking corresponding to timely payments 404 made by the tenant (John Smith, in the present embodiment), damage rating 406 indicating damages done by the tenant in the properties in which the tenant previously lived, maintenance compliance 408 indicating history of the regulatory and legal compliances followed by the tenant. Additional ranking parameters such as complaint history 410 and pet history 412 can also be included for ranking a tenant.

It should be noted that any additional parameter can be added for ranking the tenant and further, the ranking can be represented in any form or manner and can be in the form a slide bar, point system, and more. The ranking for each parameter is based on the rankings, comments, and reviews provided by other users (such as landlords of the properties in which the tenant previously lived) to the system by using the application and/or website. The tenant scoring module calculates the scores and rankings for each tenant and thus are displayed on the user interface 400.

Based on the cumulative ranking parameters 404, 406, 408, 410, 412, an overall score 414 is automatically calculated by the system 100 and is displayed as the overall score. The overall score 414 lies in one of the eleven tiers of scores defined in the system 100 as illustrated in FIG. 11. Along with the overall score 414, a recommendation 416 for the tenant is also provided suggesting a landlord to decide to give a lease of a property to the tenant.

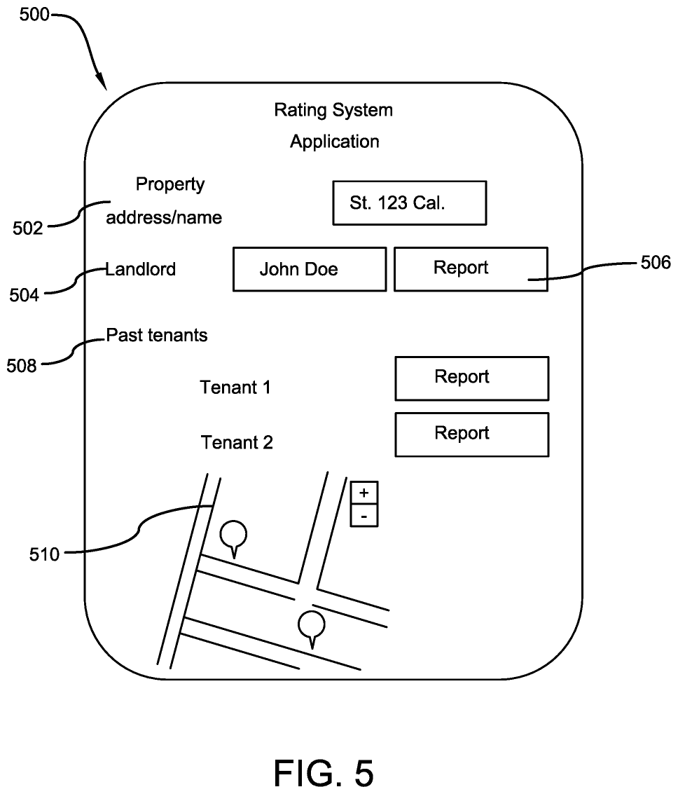

FIG. 5 illustrates an exemplary user interface of the rating system application allowing a tenant to search for a property and check scoring reports of the landlord and other tenants of the property in accordance with the disclosed architecture. The application of the present invention allows a tenant or even a landlord to search for properties and also check a specific property by inputting the address/name 502 of the property. The application then automatically displays landlord name 504 of the property 502 and a score report tab 506 of the landlord is also displayed. When the landlord score report tab 506 is clicked, then user interface 300 described in FIG. 3 will be displayed to a user.

A list 508 of past tenants in the property is also displayed along with a separate tenant report tab for each patent. The individual tenant score report tab, when clicked, takes the user to interface 400 described in FIG. 4 for providing an exhaustive analysis of the tenant. The user interface 500 also displays a map view 510 of the property searched by the user along with the directions. The term “map” as used herein may include, for example, a street-based map, a road-based map, a street map, a road map, a geographical map, a vector map, a raster map, a topographic map, a city map, a digital chart, a bird's eye view map, a satellite map, a pictorial map, a 2D map, a 3D map, a traffic map, or the like.

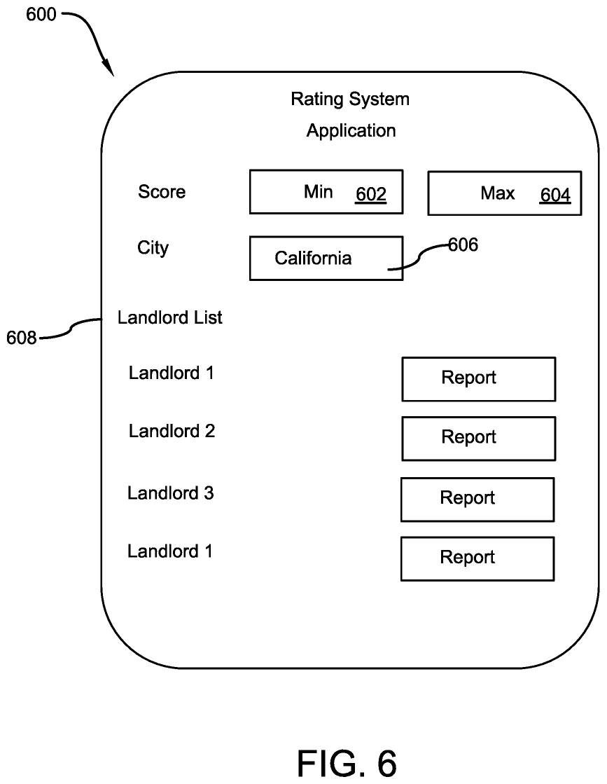

FIG. 6 illustrates an exemplary user interface of the rating system application allowing a tenant to search landlords in a specific score range for leasing a property in accordance with the disclosed architecture. The exemplary user interface 600 provides a minimum score value box 602 and a maximum score value box 604 for inputting the score range for searching landlords. Additionally, for searching landlords in a specific area, a city box 606 is also provided.

Based on the score range, a list 608 of landlords in the specific area is displayed including landlord name and a score report link for each landlord. It should be noted that similarly, the application can display a list of tenants based on the score range and a preferred location.

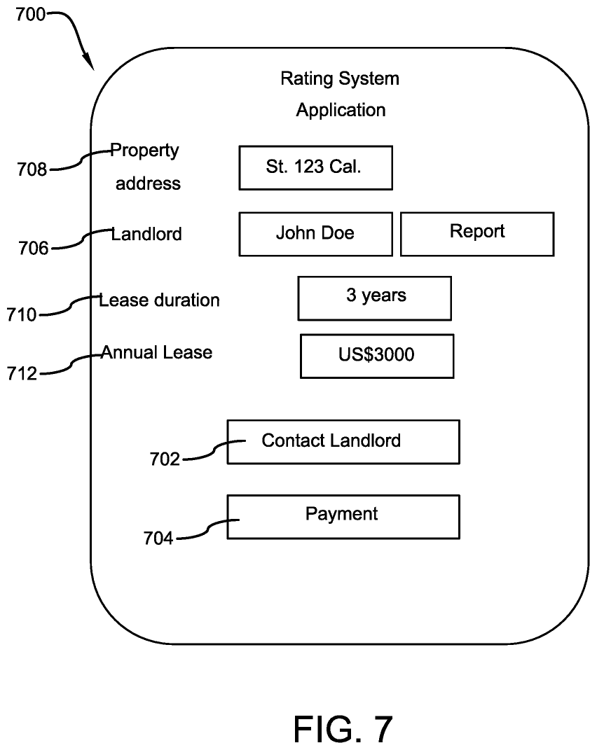

FIG. 7 illustrates an exemplary user interface of the rating system application allowing a tenant to contact a landlord and make payment in accordance with the disclosed architecture. The rating system application for landlords and tenants allows a user such as a tenant to contact a landlord using a contact button 702 and enables the user to make a payment using the payment button 704. The landlord details 706 and the property details 708 are displayed on the user interface 700 for ready reference of a user using the rating system application.

The user interface 700 also displays a lease duration 710 that can be changed as per discussion between the landlord 706 and a tenant and similarly, an annual lease 712 for the property 708 is also displayed on the user interface 700.

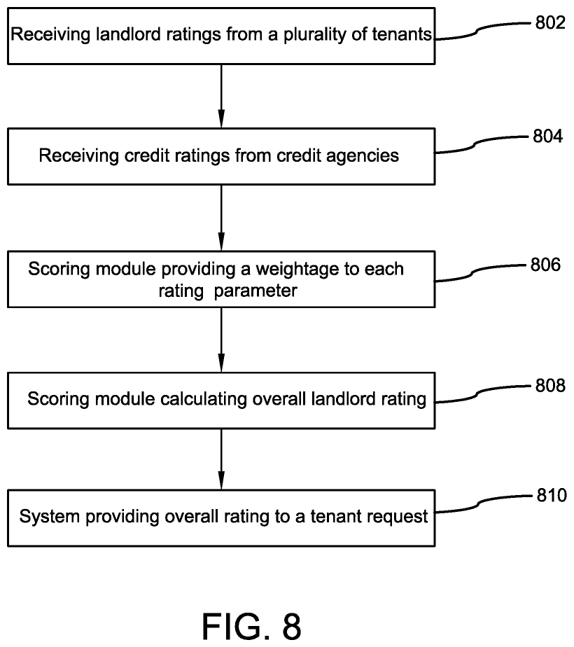

FIG. 8 illustrates a flow chart depicting a process for providing overall score/rating of landlords by the landlord and tenant rating system of the present invention in accordance with the disclosed architecture. The system is configured to receive ratings, reviews, and comments about a landlord from tenants and other landlords registered in the system (Step 802). The system is also configured to receive credit ratings from credit agencies for calculating the overall score of a landlord (Step 804). It should be noted that based on the design of the system and requirements of the users, the credit ratings can be excluded from the system.

Thereafter, the system uses a plurality of ranking of parameters to which the scores are provided by other users and a weightage is provided to each ranking parameter (Step 806). Then, the landlord scoring module calculates the overall score of each landlord registered in the system (Step 808). The system, then, based on requests from users such as tenants of the system, provides and displays the overall score of a landlord and thereby allowing tenants to obtain a preview about a landlord before signing a lease and thus helps in ensuring both parties can maintain a positive working relationship (Step 810).

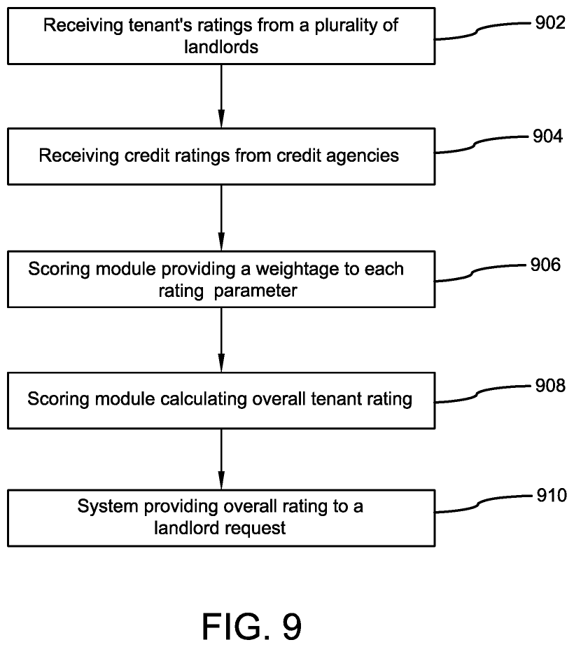

FIG. 9 illustrates a flow chart depicting a process for providing overall score/rating of tenants by the landlord and tenant rating system of the present invention in accordance with the disclosed architecture. The system is configured to receive ratings, reviews, and comments about tenants from landlords and other tenants registered in the system (Step 902). The system is also configured to receive credit ratings from credit agencies for calculating the overall score of a tenant (Step 904). It should be noted that based on the design of the system and requirements of the users, the credit ratings can be excluded from the system.

Thereafter, the system uses a plurality of ranking of parameters to which the scores are provided by other users and a weightage is provided to each ranking parameter (Step 906). Then, the tenant scoring module calculates the overall score of each tenant registered in the system (Step 908). The system, then, based on requests from users such as landlords of the system, provides and displays the overall score of a tenant and thereby allowing landlords to obtain a preview about a tenant before signing a lease and thus helps in ensuring both parties can maintain a positive working relationship (Step 910).

It should be appreciated that the system features multiple individual categories that can be assigned a score to provide a visual representation on how well a tenant pays their rent on time, previous damages caused to a property, complaint history, and more. The system allows tenants to see and dispute ratings and information, display payment, no payment, and late payment months, reports to credit agencies, and obtain other information regarding the landlord or other tenants.

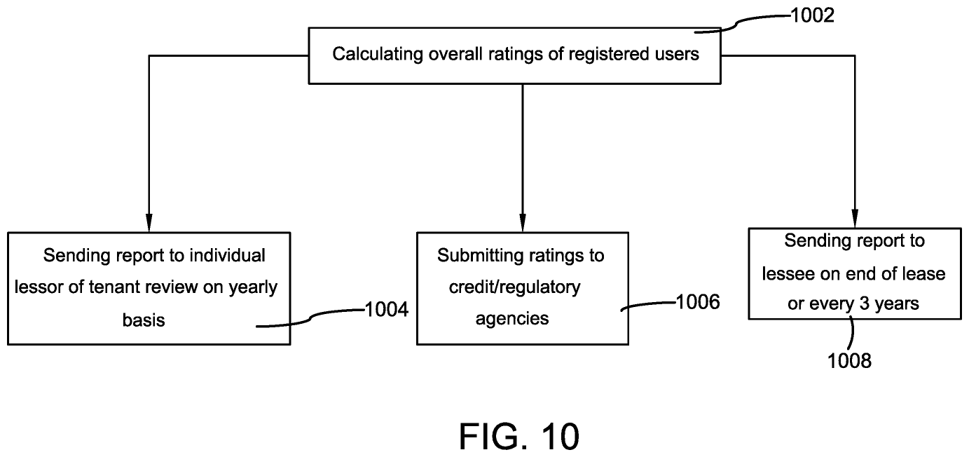

FIG. 10 illustrates a schematic flow chart showing how the score reports calculated by the system 100 of the present invention are automatically distributed to lessors and lessees in accordance with the disclosed architecture. The score reports of each user registered in the system 100 of the present invention are calculated and updated in real time based on the ratings received from users (Step 1002). Accordingly, the system provides the reports to users when requested and are also shared in either digital or physical form on predetermined times.

As illustrated, the score report of a lessor is transmitted to the individual lessor on, for example, a yearly basis wherein the report includes the rating on a variety of parameters as discussed earlier in the disclosure (Step 1004). As per requirements and agreements, the reports of both the lessors and lessees are transmitted periodically to third-party agencies such as regulatory and credit agencies (Step 1006). The system transmits reports to lessee at the end of a lease or in every three years (whichever is earlier) (Step 1008).

FIG. 11 illustrates the scoring system tiers of the point value system used by the renters and landlords rating system 100 of the present invention in accordance with the disclosed architecture. The system and the application may maintain review scores for each registered user via a point value system that calculates overall score based on an average score of all reviews submitted for an individual or a business by other users of the system. In one exemplary embodiment, the point value system has eleven tiers of scores grouped into four categories 1102, 1104, 1106, 1108. The first category 1102 has five tiers of scores 0-49, 50-99, 100-149, 150-199, 200-249 and the category 1102 is defined as “below threshold” or “not recommended”.

The second category 1104 has three tiers of scores 250-299, 300-349, 350-399 and the category 1104 is defined as “threshold”. The third category 1106 has a single tier of scores 400-449 and the category 1106 is defined as “above threshold”. The fourth category 1108 has two tiers of scores 450-475, 476-500 and the category 1108 is defined as “good”.

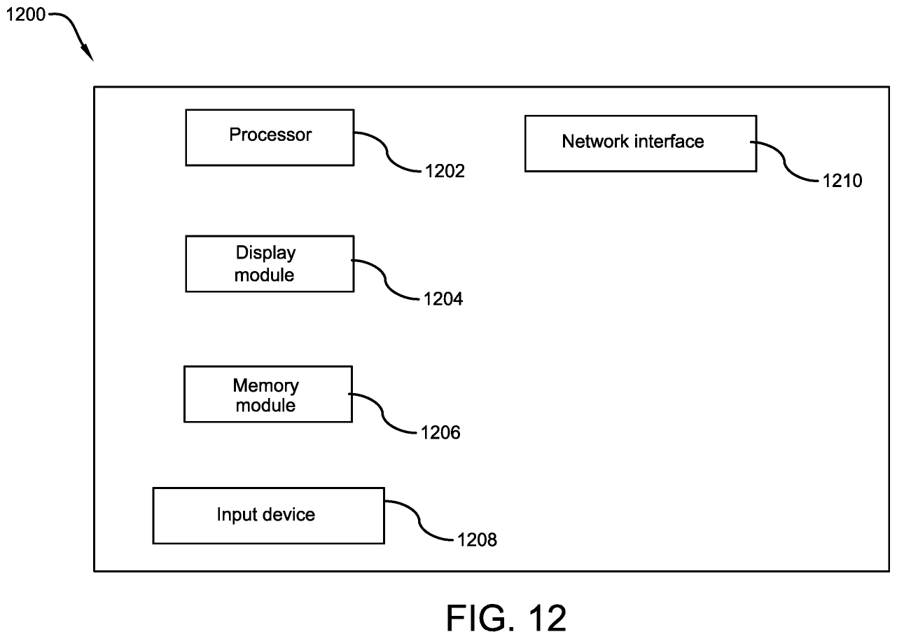

FIG. 12 depicts an exemplary computing device for implementing the rating system application of the present invention in accordance with the disclosed architecture. Computing system 1200 may be implemented on a handheld device, smart phone, laptop, or desktop computer and more as described in FIG. 1. The computing system 1200 includes a processor 1202 communicatively coupled to one or more memory modules 1206. The processor 1202 executes computer-executable program code of the rating system application stored in a memory device 1206. Examples of the processor 1202 include a microprocessor, an application-specific integrated circuit (“ASIC”), a field-programmable gate array (“FPGA”), or any other suitable processing device. The processor 1202 can include any number of processing devices or cores, including a single processing device. The functionality of the computing device may be implemented in hardware, software, firmware, or a combination thereof.

The memory module 1206 includes any suitable computer-readable medium such as electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape, or other magnetic storage, or any other medium from which a processing device can read instructions.

The computing device 1200 executes program code that configures the processor 1202 to perform one or more of the operations described above with respect to FIGS. 2-7. The computing device 1200 also includes at least one network interface 1210. The network interface 1210 includes any device or group of devices suitable for establishing a wired or wireless data connection to one or more data networks. Non-limiting examples of the network interface 1210 include an Ethernet network adapter, a modem, or the like.

A display module 1204 is configured for displaying user interfaces of the application of the present invention and the input device 1208 can be used for submitting input to the application for processing by the processor 1202.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “landlord and tenant rating system”, “rating system”, “system”, and “landlord and tenant matching system” are interchangeable and refer to the landlord and tenant rating system 100 of the present invention for sunglasses.

Notwithstanding the forgoing, the landlord and tenant rating system 100 of the present invention can be of any suitable size and configuration as is known in the art without affecting the overall concept of the invention, provided that it accomplishes the above stated objectives. One of ordinary skill in the art will appreciate that the landlord and tenant rating system 100 as shown in the FIGS. are for illustrative purposes only, and that many other configurations of the landlord and tenant rating system 100 are well within the scope of the present disclosure.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in-whole or in-part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments may include devices and/or systems using one or more suitable Operating Systems, for example, Microsoft Windows, Microsoft Windows CE, Microsoft Windows Embedded, Microsoft Windows Mobile, Unix, iOS, Linux, Sun Solaris, Palm OS, J2ME, BREW, an OS used by BlackBerry device(s), or other suitable Operating Systems.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tenant and landlord rating and scoring system comprising:
a computer implemented rating system application on a computing device, wherein said rating system application connected to a server of a communication network;
a plurality of tenant parameters assigned for calculating a score of a tenant;
a plurality of landlord parameters assigned for calculating a score of a landlord;
an interface for accessing said rating system application;
wherein said server comprises a tenant database for storing and rating said plurality of tenant parameters selected from a group consisting of a tenant name, an address, a contact detail, a rent payment history, a previous residential history, a review, a compliance failure, and a criminal record;
wherein said server comprises a landlord database for storing and rating said plurality of landlord parameters selected from a group consisting of a landlord name, an associated property, a contact detail, a review, a criminal record, an ownership history, a comment, and a photo;
a tenant scoring module for ranking said plurality of tenant parameters of said tenant database, wherein said rating of said plurality of tenant parameters and said ranking of said plurality of tenant parameters calculated for said score of a tenant;
a landlord scoring module for ranking said plurality of landlord parameters of said landlord database, wherein said rating of said plurality of tenant parameters and said ranking of said plurality of landlord parameters calculated for said score of a landlord;
wherein said score of a tenant reviewed by a landlord to assist in deciding to lease to a tenant; and
wherein said score of a landlord reviewed by a tenant to assist in deciding to take the lease of said landlord.

2. The tenant and landlord rating and scoring system of claim 1 further comprising a property database for storing at least a first said landlord database and a second said landlord database.

3. The tenant and landlord rating and scoring system of claim 1, wherein said ranking of said plurality of tenant parameters include weightages for calculating said score of a tenant.

4. The tenant and landlord rating and scoring system of claim 3, wherein said ranking of said plurality of landlord parameters include weightages for calculating said score of a landlord.

5. The tenant and landlord rating and scoring system of claim 4, wherein said communication network having a communication signal selected from a group consisting of a radio frequency (RF), an infrared (IR), a frequency-division multiplexing (FDM), an orthogonal FDM (OFDM), a time-division multiplexing (TDM), a time-division multiple access (TDMA), an extended TDMA (E-TDMA), a general packet radio service (GPRS), an extended GPRS, a code-division multiple access (CDMA), a wideband CDMA (WCDMA), a CDMA 2000, a discrete multi-tone (DMT), a Bluetooth (®), a global positioning system (GPS), a Wi-Fi, a ZigBee™, and a global system for mobile communication (GSM).

6. The tenant and landlord rating and scoring system of claim 5, wherein said server is selected from a group consisting of a centralized server, a distributed server, and a cloud server.

7. The tenant and landlord rating and scoring system of claim 4 further comprising a recommendation module for recommending a tenant to a landlord based on said score of a tenant.

8. The tenant and landlord rating and scoring system of claim 7, wherein said recommendation module for recommending a landlord to a tenant based on said score of a landlord.

9. The tenant and landlord rating and scoring system of claim 8 further comprising a payment module for performing a lease payment from said tenant to said landlord.

10. The tenant and landlord rating and scoring system of claim 9, wherein said server coupled to a third-party credit agency for receiving financial credit reports of said tenant.

11. The tenant and landlord rating and scoring system of claim 1, wherein said server comprises selectively a tenant user interface and a landlord user interface.

12. The tenant and landlord rating and scoring system of claim 1, wherein said landlord database for storing and rating said plurality of landlord parameters selected from a group consisting of a condition of a property, a speed of repair, a move-in condition, and a complaint history.

13. The tenant and landlord rating and scoring system of claim 1, wherein said tenant database for storing and rating said plurality of tenant parameters selected from a group consisting of a damage rating, a maintenance compliance, a complaint history, and a pet history.

14. A tenant and landlord rating and scoring system comprising:
a computer implemented rating system application on a computing device, wherein said rating system application connected to a server of a communication network;
a plurality of tenant parameters assigned for calculating a score of a tenant;
a plurality of landlord parameters assigned for calculating a score of a landlord;
an interface for accessing said rating system application;
wherein said server comprises a tenant database for storing and rating said plurality of tenant parameters selected from a group consisting of a tenant name, an address, a contact detail, a rent payment history, a previous residential history, a review, a compliance failure, a criminal record a damage rating, a maintenance compliance, a complaint history, and a pet history;
wherein said server comprises a landlord database for storing and rating said plurality of landlord parameters selected from a group consisting of a landlord name, an associated property, a contact detail, a review, a criminal record, an ownership history, a comment, a photo, a condition of a property, a speed of repair, a move-in condition, and a complaint history;
a tenant scoring module for ranking said plurality of tenant parameters of said tenant database, wherein said rating of said plurality of tenant parameters and said ranking of said plurality of tenant parameters calculated for said score of a tenant;
a landlord scoring module for ranking said plurality of landlord parameters of said landlord database, wherein said rating of said plurality of tenant parameters and said ranking of said plurality of landlord parameters calculated for said score of a landlord;
wherein said score of a tenant reviewed by a landlord placed into one of a series of tiers of scores;
wherein said score of a landlord reviewed by a tenant placed into one of said series of tiers of scores; and
further wherein said server comprises selectively a tenant user interface and a landlord user interface.

15. The tenant and landlord rating and scoring system of claim 14 further comprising a property database for storing at least a first said landlord database and a second said landlord database.

16. The tenant and landlord rating and scoring system of claim 15, wherein said server is selected from a group consisting of a centralized server, a distributed server, and a cloud server.

17. The tenant and landlord rating and scoring system of claim 16 further comprising a payment module for performing a lease payment from said tenant to said landlord.

18. The tenant and landlord rating and scoring system of claim 17, wherein said server coupled to a third-party credit agency for receiving financial credit reports of said tenant.

19. A method of rating and scoring a tenant and a landlord, the method comprising the steps of:
providing a computer implemented rating system application on a computing device, wherein said rating system application connected to a server of a communication network;
assigning a plurality of tenant parameters for calculating a score of a tenant;
assigning a plurality of landlord parameters for calculating a score of a landlord;
accessing an interface for said rating system application;
wherein said server comprises a tenant database for storing and rating said plurality of tenant parameters selected from a group consisting of a tenant name, an address, a contact detail, a rent payment history, a previous residential history, a review, a compliance failure, a criminal record a damage rating, a maintenance compliance, a complaint history, and a pet history;
wherein said server comprises a landlord database for storing and rating said plurality of landlord parameters selected from a group consisting of a landlord name, an associated property, a contact detail, a review, a criminal record, an ownership history, a comment, a photo, a condition of a property, a speed of repair, a move-in condition, and a complaint history;
ranking said plurality of tenant parameters of said tenant database, wherein said rating of said plurality of tenant parameters and said ranking of said plurality of tenant parameters for said calculating said score of a tenant;
ranking said plurality of landlord parameters of said landlord database, wherein said rating of said plurality of landlord parameters and said ranking of said plurality of landlord parameters for said calculating said score of a landlord; and
reviewing said score of a tenant by a landlord to assist in deciding to lease to a tenant.

20. The method of claim 19 further comprising a step of reviewing said score of a landlord by a tenant to assist in deciding to take a lease from said landlord.
